(19) United States
(12) Patent Application Publication
(10) Pub. No.: US 2011/0024532 A1
(43) Pub. Date: Feb. 3, 2011

(54) Carcass Composter

(75) Inventors: C. Hugh Stevenson, Petrolia (CA); Malcolm Newall, Petrolia (CA); Kevin LaPaire, Petrolia (CA)

Correspondence Address: SHOEMAKER AND MATTARE, LTD, 10 POST OFFICE ROAD - SUITE 100, SILVER SPRING, MD, 20910, US

(73) Assignee: CONTAINER DESIGN CORPORATION, Petrolia (CA)

(21) Appl. No.: 12/691,394

(22) Filed: Jan. 21, 2010

Related U.S. Application Data
(60) Provisional application No. 61/146,184, filed on Jan. 21, 2009.
(60) Provisional application No. 61/150,563, filed on Feb. 6, 2009.

(51) Int. Cl. B02C 19/00

(52) U.S. Cl. 241/25; 241/220

(57) ABSTRACT

An apparatus for shredding animal carcasses has a pair of counter-rotating shafts, each of which supports a stack of alternating pug tooth elements and untoothed spacers of about the same thickness so that the pug tooth elements intermesh. Each pug tooth element has a base circle and a tooth with a forward rake, which tooth extends substantially beyond the base circle of the element. Carcasses are fed into the apparatus while the shafts are rotated by a drive mechanism, producing a shredded material which may be composted above ground.

This application claims benefit of provisional applications 61/146184, filed Jan. 21, 2009, and 61/150563, filed Feb. 6, 2009.

### BACKGROUND OF THE INVENTION

This invention relates to an apparatus for comminuting dead animal carcasses. This enables the carcass material to be composted in windrows, or otherwise disposed of or used.

Farm animals who die and cannot be butchered must be disposed of in an acceptable way. Cremation introduces carbon dioxide and other undesirable gases into the atmosphere; burying can infect ground water; and whole-animal composting is a slow process.

Prior inventors have proposed various machines for comminuting or shredding carcasses. This invention is an improvement over such prior devices.

### SUMMARY OF THE INVENTION

An object of the invention is to provide a machine, preferably a portable machine, which can shred carcasses of whole large animals such as pigs, horses and cows so that they can be efficiently composted above ground in an environmentally acceptable way.

These and other objects are attained by a carcass composter as described below.

### BRIEF DESCRIPTION OF THE DRAWINGS

In the accompanying drawings,

FIG. 1 is a top plan sectional view of a carcass composter embodying the invention;

FIG. 2 is a front elevation thereof;

FIG. 3 is a left side elevation thereof;

FIG. 4 is a top plan view of a top gear box cover for the composter;

FIG. 5 is a bottom plan view of a bottom gear box cover therefor;

FIG. 6a is a side elevation of one of the pug tooth elements shown in FIG. 1;

FIG. 6b is a top plan view thereof;

FIG. 6c is a front elevation thereof;

FIGS. 7a- 7l are details of static structural elements forming the composter housing; and

FIGS. 8a- 8l are details of rotating elements contained within the housing.

### DESCRIPTION OF THE PREFERRED EMBODIMENT

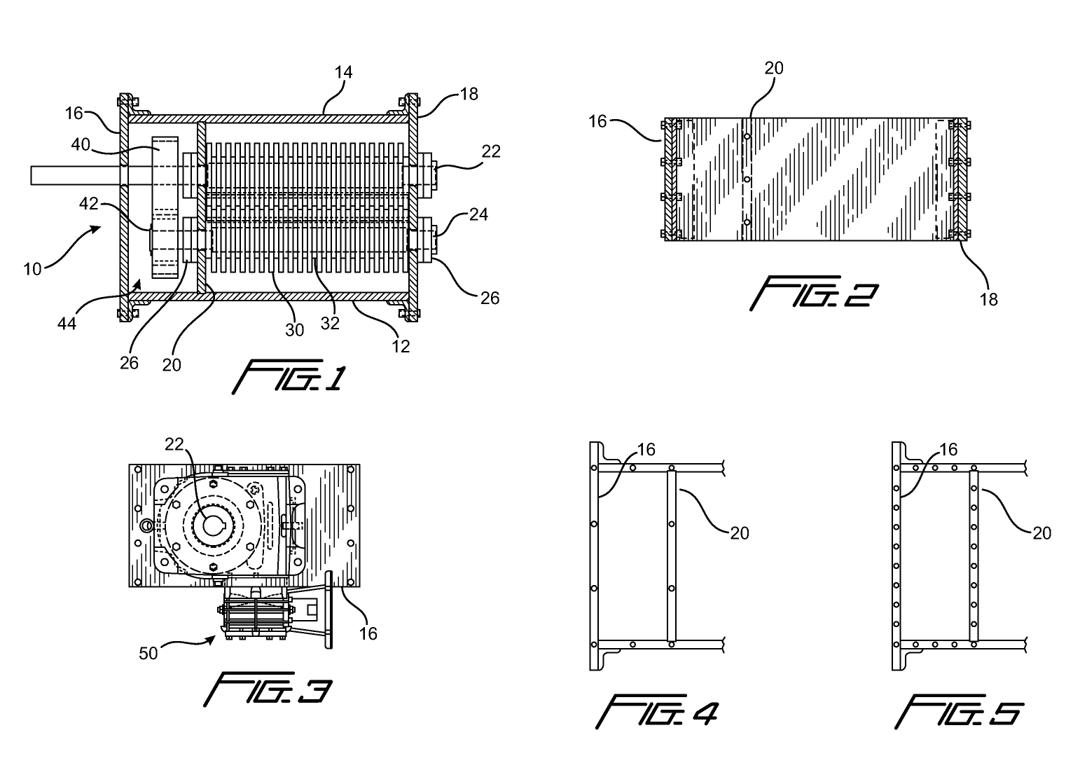

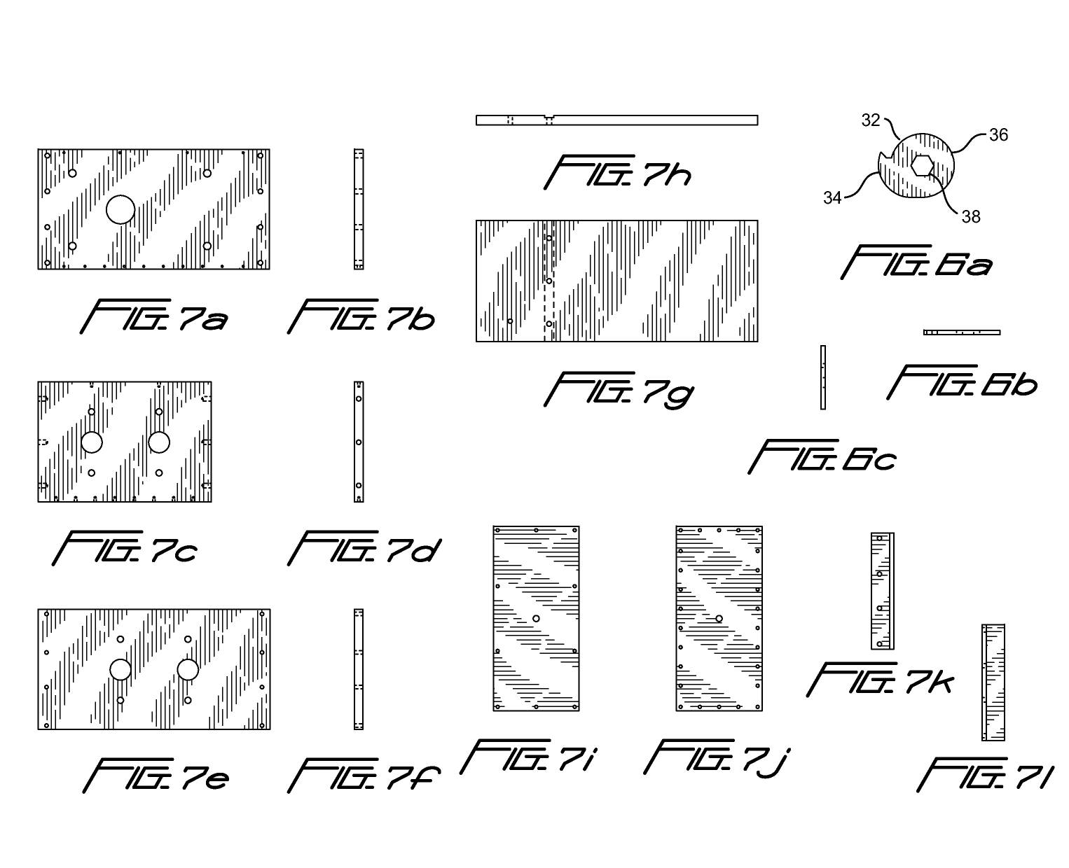

A carcass composter embodying the invention comprises a housing 10 (FIG. 1) formed from a pair of side plates 12, 14 interconnected by a pair of end plates 16, 18 and a center plate 20 (see detail, FIG. 7a). The end plates and center plates have aligned bores which support a pair of parallel shafts 22, 24, each of which has cylindrical ends and a center portion whose cross-section is hexagonal. The shafts, shown in detail in FIGS. 8i, 8j, 8k and 8l, are supported by bearings such as Dodge Grip tight 2-bolt flange bearings 26 bolted to the right end plate and the center plate.

As shown in FIG. 1, a stack of alternating pug tooth elements 30 and untoothed spacers 32 (see detail, FIGS. 8a, 8b) of about the same thickness is mounted on each of the shafts, forming rotor assemblies. The stacks are axially offset so that each pug tooth element on one shaft faces a spacer on the other shaft, and the pug tooth elements intermesh.

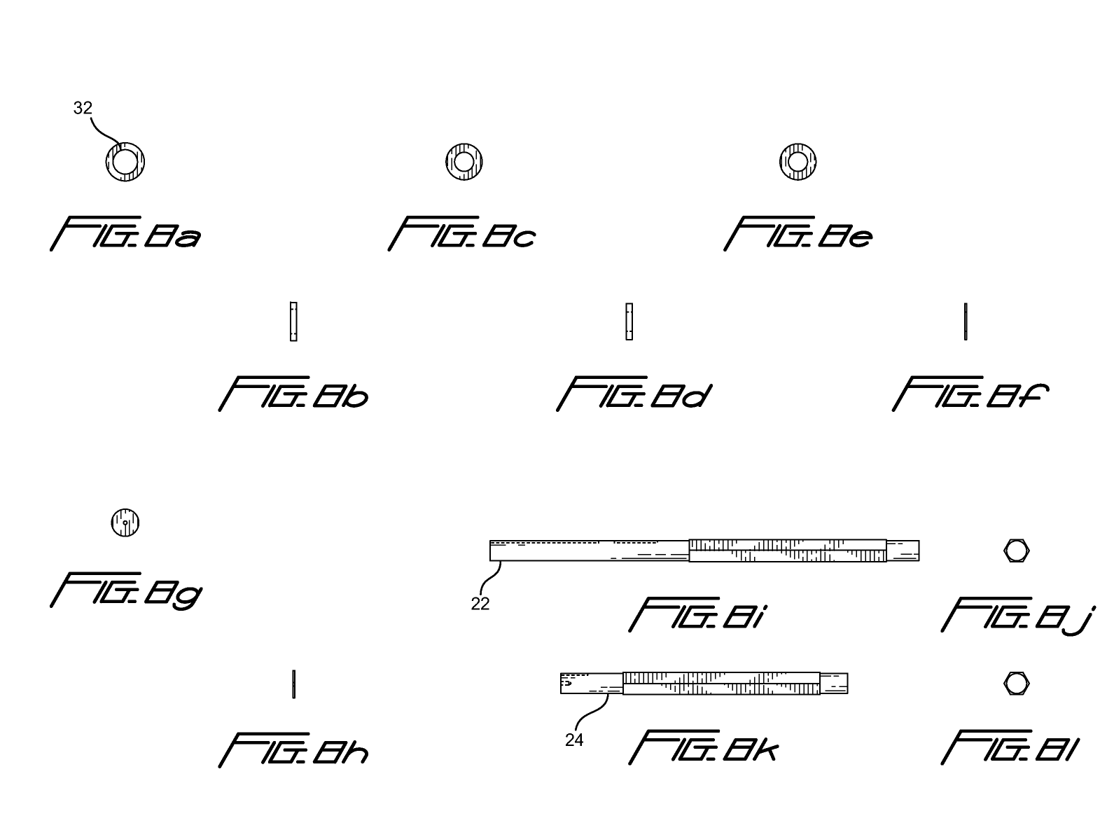

Each pug tooth element 30 (see detail, FIGS. 6a, 6b, 6c) has a single tooth 34 with a forward rake, which extends about 1-³4 inch beyond the base circle 36 of the element. The preferred thickness is about 1/2 inch for this size element. The parts may be scaled up or down depending on the intended use. Each element has a hexagonal center hole 38 sized to fit on the hexagonal portion of a respective shaft. The hexagonal shaped mentioned above are presently preferred, but any non-circular shape (including splines and keys) could be substituted.

The pug tooth elements are arranged in mirror-image fashion on the two shafts, and the shafts are caused to rotate in opposite directions by a pair of spur gears 40, 42 (FIG. 1) in constant mesh at one end of the housing. The spur gears should not be the same size, and preferably have a tooth ratio of about 7:8. At least one of the gears should have a prime number of teeth, and the gears should not be identical so that each tooth on one gear engages every tooth on the other gear over time, which is best for clearing debris. Preferably, both gears have prime number of teeth. The gear ratio may be changed as needed for various applications. The gears are contained in a clean gearbox 44 defined between the left end plate and the center plate. This compartment is sealed top and bottom by top and bottom gear box covers 46, 48 (FIGS. 7i and 7j).

One of the two shafts 22 extends out of the end of the gearbox, for connection to a driving mechanism 50. The mechanism, shown in FIG. 3, may have a right angle drive and an adapter for connection to a motor such as a five-horsepower electric motor (not shown), engine or other source of power. The motor is preferably operated by a controller 60 which can reverse the direction of the motor in order to clear the teeth.

In operation, the driving mechanism is actuated, turning the rotors in opposite directions so that the opposed teeth approach each other at the top of the unit. A carcass is then fed in at the top, and the teeth draw the carcass through the composter as they shred it. An articulated hopper (not shown) may be secured to the top of the device for safety reasons and to aid the infeed process. Comminuted material falls from the bottom of the device and is collected and mixed with other materials such as straw for immediate or subsequent arrangement in windrows. Alternatively, the pulped material can be utilized to produce other forms of energy in other processes.

If the machine become clogged or jammed, a reversing feature on the power source assists in clearing any material obstruction.

Since the invention is subject to modifications and variations, it is intended that the foregoing description and the accompanying drawings shall be interpreted as only illustrative of the invention.

We claim:

1. An apparatus for shredding animal carcasses comprising
a housing having bearings defining a pair of parallel axes,
a pair of parallel rotor assembly shafts supported in the housing by said bearings,
each of said shafts having a gear mounted thereon, the gears meshing with one another so that the shafts rotate in opposite directions.
a driving mechanism for turning one of said shafts,
each of said shafts having a drive portion with a non-circular cross-section,
a stack of alternating pug tooth elements and untoothed spacers of about the same thickness, mounted on the respective shafts,
the stacks being axially offset so that each pug tooth element on one shaft faces a spacer on the other shaft, and the pug tooth elements intermesh,
each pug tooth element having a base circle and a tooth with a forward rake, which tooth extends substantially beyond the base circle of the element,
each pug tooth element having a non-circular hole sized to fit the non-circular portion of a respective shaft, and
the pug tooth elements being arranged in mirror-image fashion on the two shafts.

2. The apparatus of claim 1, wherein said gears have a different number of teeth.

3. The apparatus of claim 1, wherein said gears have a tooth ratio of about 7:8.

4. The apparatus of claim 1, wherein at least one of said gears has a prime number of teeth.

5. The apparatus of claim 1, wherein each of said gears has a prime number of teeth.

6. The apparatus of claim 1, wherein the gears are contained in a sealed gearbox defined between the left end plate and the center plate.

7. The apparatus of claim 1, wherein said mechanism comprises
a motor or engine,
a right angle drive and
an adapter for connecting one of said shafts to the motor or engine.

8. The apparatus of claim 1, further comprising a controller for the motor which can reverse the direction of the motor in order to clear the teeth.

9. A method of composting an animal carcass, said method comprising steps of
feeding said carcass into a shredding mechanism having interleaved toothed elements mounted on counter-rotating shafts, to produce shredded carcass material and
composting said shredded material above ground.
